(19) United States
(12) Patent Application Publication
(10) Pub. No.: US 2010/0255449 A1
(43) Pub. Date: Oct. 7, 2010

(54) INTERACTIVE VIDEO TRAINING OF PERCEPTUAL DECISION-MAKING

(76) Inventor: Peter J. Fadde, Carbondale, IL (US)

Correspondence Address: HARNESS, DICKEY, & PIERCE, P.L.C, 7700 Bonhomme, Suite 400, ST. LOUIS, MO, 63105, US

(21) Appl. No.: 12/750,952

(22) Filed: Mar. 31, 2010

Related U.S. Application Data
(63) Continuation of application No. 11/327,187, filed on Jan. 6, 2006, now abandoned.
(60) Provisional application No. 60/641,798, filed on Jan. 6, 2005.

(51) Int. Cl. G09B 19/00; G09B 5/00; A63B 69/00

(52) U.S. Cl. 434/236; 434/307 R; 434/247

(57) ABSTRACT

An interactive video training method is provided for targeting and enhancing cognitive recognition in a rapid response performance skill is provided. The method comprises identifying a cognitive component of performance skill requiring a rapid response in a limited time, developing video occlusion techniques for measuring cognitive expertise of an individual in recognizing and selecting an accurate response, and applying the video occlusion techniques for the purpose of mediated training for enhancing an individual's skills in recognizing and selecting an accurate response in the performance skill. The method may further comprise the step of measuring the improvement in the individual's performance skill after application of the video occlusion techniques.

### CROSS-REFERENCE TO RELATED APPLICATIONS

This application is a continuation of U.S. patent application Ser. No. 11/327,187 filed on Jan. 6, 2006 which claimed the benefit of U.S. Provisional Patent Application Ser. No. 60/641,798, filed on Jan. 6, 2005, the entire disclosure of which is incorporated herein by reference.

### BACKGROUND OF THE INVENTION

Perceptual decision-making (PDM) entails visual recognition and response selection in extremely limited time frames. PDM is involved in skill areas such as use-of-force, emergency response, and vehicle operation. PDM is also essential to high-level performance in reactive sports skills, such as hitting a pitched baseball. Sports may provide an environment in which offer the potential to improve PDM skills, which are usually conceded to come only from instinct or significant experience.

### SUMMARY OF THE EMBODIMENTS

The present invention relates to systems and methods for providing interactive training that will enhance perceptual decision making skills where a rapid response within a limited time period is required. In some embodiments of the present invention, an interactive video training method for targeting and enhancing cognitive recognition in a rapid response performance skill is provided. The method comprises identifying a cognitive component of performance skill requiring a rapid response in a limited time, developing video occlusion techniques for measuring cognitive expertise of an individual in recognizing and selecting an accurate response, and applying the video occlusion techniques for the purpose of mediated training for enhancing an individual's skills in recognizing and selecting an accurate response in the performance skill. The method may further comprise the step of measuring the improvement in the individual's performance skill after application of the video occlusion techniques. In one or more embodiments of the present invention, the cognitive component of the method comprises a perceptive decision making skill of reacting to a rapidly moving object. In one embodiment, the method includes a video occlusion technique comprising displaying a brief video clip of a rapidly moving object to an individual, and having the individual select a response based on the viewer's perception of the video. In this method, applying the video occlusion technique comprises progressively reducing the viewing time of the rapidly moving object in the video to train the individual to more rapidly recognize and select an accurate response. The method calls for the individual to select a predicted outcome to the rapidly moving object video, and immediately provides the individual with the outcome of the rapidly moving object after the individual has made a selection.

In accordance with one aspect of the present invention, one embodiment is provided for an interactive video training system for providing mediated training to improve a sports performance based skill requiring a rapid response in a limited time period. The interactive video system comprises a video means for displaying to an individual a video of a rapidly moving object for a limited viewing time, and a selection means for enabling the individual to select a predicted outcome of the rapidly moving object, wherein the video means is capable of progressively reducing the viewing time of the rapidly moving object to train the individual to more rapidly recognize and select an accurate response to the rapidly moving object for enhancing the individual's sports performance skill.

In another aspect of the present invention, various embodiments of methods for providing interactive video training are provided. The various embodiments of interactive video training methods for targeting and enhancing cognitive recognition in a rapid response performance skill, involve displaying a brief video clip of a rapidly moving object to an individual. In some embodiments, the rapidly moving object may be a baseball pitch for improving pitch recognition, or a tennis ball serve for improving serve recognition, or a hockey puck shot for improving goal tender response. In yet another embodiment of a method of providing use-of-force training, the rapidly moving object is an armed perpetrator for improving officer training.

### BRIEF DESCRIPTION OF THE DRAWINGS

FIG. 1 shows one embodiment of an interactive video image of a pitch response system and method in accordance with the principles of the present invention;

FIG. 2 shows a strike zone target grid of the pitch response system and method;

FIG. 3 shows post training batting statistics derived from one embodiment of the present invention;

FIG. 4 shows the statistical batting average of a subject group employing the system and method of the present invention;

FIG. 5 shows the statistical on base percentage of a subject group employing the system and method of the present invention; and

FIG. 6 shows the statistical slugging percentage of a subject group employing the system and method of the present invention.

### DETAILED DESCRIPTION OF THE EMBODIMENTS

The training-based research project disclosed in the present application used an interactive video program to practice and improve the pitch recognition ability of college baseball players. The instructional intervention significantly improved the game batting performance of subjects. The research findings suggest that PDM can be targeted for training, that PDM training can be cone using modest instructional technology, and that mediated PDM training can lead to improved performance of the overall skill. Applications extend well beyond sports.

The methods according to the principles of the present invention are the result of a training-based research project that addresses key questions concerning mediated training of perceptual decision-making (PDM). The first questions deal with what PDM is and how it relates to expert performance. Far from being an academic exercise, how PDM is defined has a substantial influence on approaches to training. Other questions related to the instructional technology and methods that are appropriate for mediated training of PDM. The training approach taken draws on sports science research grounded to cognitive information processing theory that supports separate training of the cognitive and physical components of a complex psychomotor skill. Specifically, the training program reported on was designed to target pitch recognition as the perceptual decision-making component of the complex psychomotor skill of hitting a baseball.

In describing various embodiments of a method for providing mediated training of perceptual decision-making skills, the present application will 1) delineate PDM as a distinct domain of cognitive processing. 2) describe an interactive video training implementation that improved the pitch recognition skill of baseball batters, 3) detail the “repurposing” of research techniques designed to measure PDM into training techniques designed to improve PDM, and 4) discuss considerations of how mediated PDM training can apply to a wide range of skills well beyond the realm of sports. These include use-of-force training for police and military, emergency response, security, and vehicle operation.

At least some embodiments of the present invention relate to the area of sports, and focus on sports applications for two reasons. One reason is that performance in sports is more contained, definable, and measurable than in areas like emergency response. Sports provide a laboratory in which to develop training techniques that may be applied to other, arguably more socially important, areas. Another reason for focusing on sports skills is that there is a body of sports science theory and research that has focused on perceptual decision-making as an essential aspect of expert performance. Thus, the present invention will provide conceptual definitions of perceptual decision-making (PDM) skills as they relate to sports, and examples of such PDM skills in sports such as Pitch Recognition.

### Perceptual Decision-Making in Sports

Perceptual decision-making skills (PDM) is the essence of expert performance in many sports skills. PDM refers to the ability to recognize situations using perceptual cues (mostly visual) and make extremely rapid response selections. PDM is involved in reactive sports skills, such as blocking shots-on-goal in hockey and soccer, return-of-serve in tennis, and hitting a pitched baseball. These sports skills require participants to recognize visual cues, select a response, and execute the response in time frames that challenge simple human reaction time (McLeod & Jenkins, 1991)—less that one-half second.

Using an expert-novice paradigm, sports science research shows that experts are able to make faster as well as more accurate decisions in situations that involve limited decision time and perceptual information (Chamberlain & Coehlo, 1993). Such studies typically involve subjects viewing film/video clips of an opponent's action, such as a baseball pitch or a tennis serve, filmed from the point of view of a participating player. The “expert” and “novice” subjects are asked to identify the type and location of the pitch or serve. Different experimental trials show less or more ball flight (temporal occlusion) and measure subjects' speed as well as accuracy in making predictions. A smaller body of research has studied training implementations that apply the temporal occlusion techniques of expert-novice research. Most of theses studies have shown a positive effect of film/video-based occlusion training on improving PDM (Farrow, 1998) and at least one (Fadde, 2002) shows a positive and significant effect of mediated PDM training on game performance of the fully psychomotor skill.

### Definition of Pitch Recognition

This paper reports on a training-based research project that targeted the PDM skill of pitch recognition in the sport of baseball. At high levels of competition the baseball batter has less than 500 milliseconds to decide whether to swing the bat and where and when to direct the swing in order to coincide with the arrival of the ball. Ted Williams called it the most difficult thing to do in sports (Williams & Underwood, 1970).

Pitch recognition has long been recognized as an essential aspect of baseball hitting (see Fadde, 2002 for a complete review of instructional batting books). However, there is little agreement on what the skill consists of and little advice on how to improve it. This is in great part because pitch recognition happens too quickly and subconsciously to be verbally explained by expert batters (Abernethy et al., 1993).

While sports scientists have investigated pitch recognition as an essential element of the complex skill of baseball hitting, they have not attempted to describe the skill or the thought process involved. What the sports science research does do is to isolate where and when in the opponent pitcher's movements that expert hitters are able to glean information (Paull & Glencross, 1997). Sports science researchers focus on two components of pitch recognition: identifying the type of pitch being thrown (curveball, fastball, slider, changeup, etc.) and predicting the eventual location of the pitch in the strike zone. These two components of pitch recognition are used as the operational definition of the skill for training as well as research purposes.

It is important to differentiate pitch recognition, as a form of perceptual decision-making, from the tactical decision-making that has long been a part of baseball lore and teaching. Ted Williams gives the definitive explanation of tactical hitting in his seminal book The Science of Hitting (Williams & Underwood, 1970). Tactical decision-making happens before a pitch is delivered and is focused on anticipating what type of pitch might be thrown, and to what location. Williams' approach to selective and tactical hitting is highly influential in the modern game of baseball.

Tactical decision-making has a role in pitch recognition in that it enable s the batter to reduce the alternatives, lowering the cognitive load and “priming” the recognition decision (Paull & Glencross, 1997). Sports science researchers have found that pre-pitch information does improve batter's ability to predict pitch location (Gray, 2002). However, tactical (pre-pitch) decision-making is not the same as perceptual decision-making (see Fadde, 2002 for complete Task Analysis of Pitch Recognition). They are entirely different cognitive processes that suggest different training approaches.

### Domain of Perceptual Decision-Making

Perceptual decision-making is not a physiological attribute of vision. Such attributes, like dynamic tracking acuity and peripheral vision, have been shown by sports science research to not be primarily responsible for expert-novice differences (Chamberlain & Coehlo, 1993). Sports scientists taking a cognitive information processing (CIP) view of perceptual decision-making have studied it using the expert-novice paradigm. The classic CIP expert-novice chess studies (Simon & Chase, 1973) showed that chess masters do not posses prodigious memory for random placement of chess pieces on a board but rather context-specific schema that enable them to remember meaningful arrangements of chess pieces. Sports scientists using expert-novice studies of reactive sports skills have come to the same conclusion, that the experts' advantage is a software rather than a hardware advantage (Chamberlain & Coehlo, 1993).

Although it is associated with psychomotor performance, PDM is a distinctly cognitive process. However, as described above, PDM is different from strategic, rule-based decision-making. Classic theories of optimal decision-making involve accessing the alternatives and predicting the likelihood of their success. This isn't possible in contexts of extremely limited information and time (Gonzalez et al., 2001). So, while there are considerable bodies of psychology research on both perception and decision-making, neither applies to the domain of perceptual decision-making.

The importance of delineating a distinct domain of cognition for PDM is that it suggests particular training approaches. Rule-based decision-making is appropriately taught using tutorial instructional methods and practiced with simulation. PDM is “instance based” rather than “rule based” (Gonzalez et al., 2001) and therefore is more appropriately trained using drill and practice techniques (Alessi & Trollip, 2001). PDM isn't a skill that is taught, like riding a bike, so much as it is trained; in the same way that strength training is used to develop specific muscle groups.

### Pitch Recognition Research

Sports science researchers focusing on understanding perceptual decision-making have used film/video-based recognition tasks to measure the target skill. TN these experimental tasks, the subject typically views a visual representation of an opponent's action that is shot from the point-of-view of a participating player (e.g. Abernethy, 1991). The visual display is cut off at various points in time during the opponent's action and resulting ball flight. Such temporal occlusion tasks are used to measure differences in the skill level of expert and novice performers in predicting the outcome of an opponent's action based on limited visual information. Experts generally make more accurate and faster predictions, especially when viewing drastically restricted display.

In baseball, Paull and Glencross (1997) found that players in the top-grade Australian professional baseball league (experts) were superior to lower-grade professional player (novices) in their ability to identify the type of pitch and predict its ultimate location over the plate. Complementing the body of expert-novice research is a smaller body of training-based studies (all training baseball pitch recognition or tennis serve recognition) that show that perceptual decision-making skills can be improved through temporal occlusion training (Farrow, 1998).

The method of the present invention addresses the key questions of whether laboratory-measured training gains transfer to psychomotor performance of the skill. Burroughs (1984) trained college baseball players using film techniques and then measured their performances in a live test that duplicated the laboratory task. Burroughs devised the Visual Interruption System—a specially designed batting helmet with a face shield that dropped in front of the batter's eyes shortly after the pitcher released the ball. The players in the film-occlusion training group were better able to identify pitch type and predict pitch location in the V.I.S. live occlusion task. While Burroughs' test demonstrated near transfer of the specific skill of pitch recognition from the mediated training task to a live testing task, one embodiment of a method according to the principles of the present invention demonstrated a positive effect of mediated pitch-recognition training of performance of the full skill of hitting in the competitive context. The method comprises Division I college baseball players who received interactive video pitch-recognition training performed better than a control group of players over a post-training period of games. The performance was measured using the game-hitting statistics of batting average, on-base percentage, and slugging percentage.

### Repurposing Sports Science Research for Training

The design of one embodiment of the present invention of an interactive video-baseball (IAV-BB) pitch-recognition training method is based on techniques developed by sports scientists to research the differences between “experts” and “novices” in perceptual decision-making tasks such as pitch recognition. Sports science researchers investigating PDM have developed film/video occlusion techniques for describing when (temporal occlusion) and where (spatial occlusion) the expert is “seeing” information that the notice is not. Spatial occlusion tasks, in which portions of the video display are masked, have provided little meaningful information beyond observing that expert batters concentrate more intently on the pitcher's release point. The temporal occlusion studies have been more valuable for isolating the points in time where experts pick up usable information. Paull and Glencross (1997) found that the difference between experts and novices lessened when more than about a third of the ball flight of the pitch was shown. Conversely, there were little differences between experts and novices at occlusion pints prior the moment-of-release of the pitch. In this embodiment, the method of training in pitch recognition is therefore be focused on the time between the release of the pitch and approximately ⅓^{rd} of the ball's flight.

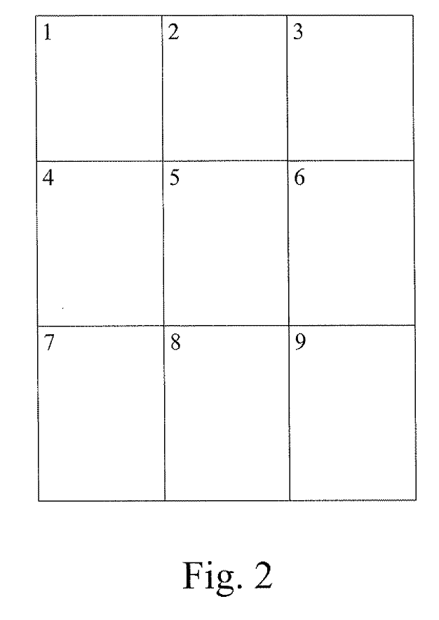

According to one embodiment of the present invention, a method of mediated training for enhancing sports performance comprises a video for IAV-BB that was shot and edited in the same way as research film/video occlusion tasks. Four pitchers were videotaped from the point of view of a batter (both left-handed an right-handed views). The clips were edited to show different amounts of ball flight. Data associated with each clip indicated the type of pitch and the location of the pitch in the strike zone (see FIG. 2).

In one embodiment of a system and method for providing mediated training to improve sports performance, each pitch was edited into clips of three different lengths. The most difficult versions of each pitch video clip cuts to black immediately after the ball leaves the pitcher's hand—the moment of release (MOR). Mid-level difficulty is represented by clips cut off at two frames of video after the pitch is released (MOR+2). The easiest clip shows five frames of video after the release of the pitch (MOR+5). Referencing the NTSC video standard of 30 frames of video per second, a single frame represents 33 milliseconds. MOR+2 therefore shows 67 milliseconds of ball flight while MOR+5 shows 165 milliseconds of ball flight . . . the outer time limit suggested by the expert-novice study of Paull and Glencross (1997).

While the video clips are prepared in the same way, there are differences between using the temporal occlusion task for research (testing) purposes and for training purposes. The question is: What needs to be done with film/video occlusion testing tasks in order to create effective interactive video drill and practice training tasks. The essential elements of the drill and practice instructional method are repetition and immediate feedback. Other instructional design elements that contribute to “repurposing” a testing task for training purposes are progressive difficulty and instructional content. Table 1 shows how these elements are used differently for testing purposes and for training purposes.

TABLE 1
Instrumental Elements Used for Testing and Training

| Element | Testing Purpose | Training Purpose |
|---|---|---|
| Repetition | Minimum to measure skill | As needed to develop skill |
| Difficulty | Mixed to avoid training | Progressive for mastery |
| Feedback | None | Immediate and corrective |
| Instruction | None | Initial and remedial |

### Repetition

For the purposes of the present invention of a method for mediated training to enhance sports performance, the goal is to use the minimum number of repetitions to assure that the state of the subject's ability is thoroughly tested, but not affected. With the purpose of the present method for mediated training in mind, the goal of drill and practice method is to provide massed repetition in order to increase speed and accuracy of cognitive or psychomotor skills to a masterly level. One of the primary attributes of mediated instruction is the ability to organize and present many more repetitions than is possible with “live” practice. Scott, Scott, and Howe (1998) gave as many as 120 ten-minute training sessions to each of the six subjects they trained in tennis return-of-serve recognition.

### Progressive Difficulty

In most of the sports expertise studies the occlusion conditions range in difficulty from a full view of the opponent's action and resulting ball flight to a view in which the action is cut off before the ball is thrown or struck. In expertise research designs, the varying levels of difficulty are mixed to measure the subject's perceptual decision-making ability to different occlusion conditions while avoiding potential training effects. With the goal of the present method shifting from testing to training, this embodiment of a method of training systematically uses different occlusion points to create progressive difficulty. This permits a mastery approach to learning in which achieving a criterion score at one level of difficulty moves the learner to the next level of difficulty. The element of progressive difficulty is familiar to athletes in the context of physical conditioning and strength training. In a similar way, but in a different domain, repetition and progressive difficulty can work together to let athletes not only learn but condition perceptual decision-making abilities.

### Feedback

Ericsson, Krampe, and Tesch-Romer (1993) in their influential article on the role of deliberate practice in the development of expertise noted that repeated exposure to a task does not ensure that the highest levels of performance will be attained. Accordingly, this embodiment of a method for mediated training provides immediate and corrective feedback, which is another essential building block of a drill and practice training program (Alessi & Trollip, 2001). In the occlusion tasks used to test perceptual decision-making ability, subjects are never given feedback on their predictions. To do so would introduce a training effect that would undermine the testing goal of the research. All of the training-based perceptual decision-making methods of the present invention, on the other hand, included immediate and corrective feedback as a basic instructional element.

### Instruction

The provision of instruction in the present method is another element that can be added to video-based occlusion tasks in order to re-purpose the tasks from testing goals to training goals. The questions with PDM training is what instruction to give. As noted earlier, the cognitive processes involved in PDM skills like pitch recognition defy analysis, and therefore instruction, using traditional cognitive information processing techniques like think-aloud unconscious. While the sports science has not been succeeded in describing the process of PDM, it has provided direction on how to train the skill. Paul and Glencross in their definitive 1997 expert-novice study of pitch recognition ran separate experiments to measure the ability of experts and novices to identify pitches and to predict their location. They determined that experts are able to identify the type of pitch at early occlusion points but need more ball flight to predict the eventual location of the pitch in the strike zone. Tennis return-of-serve studies have also differentiated identifying the type of serve and predicting the location of the serve (Scott et al., 1997; Singer et al., 1994). The research suggests a training approach in which type identification and location prediction are treated as separate components of the recognition skill. The present method for mediated training combines that separation of PDM sub-skills with the aspect of progressive difficulty from easier to more difficult occlusion points to provide a “curriculum” for pitch recognition training.

### Interactive Video Pitch Recognition Training

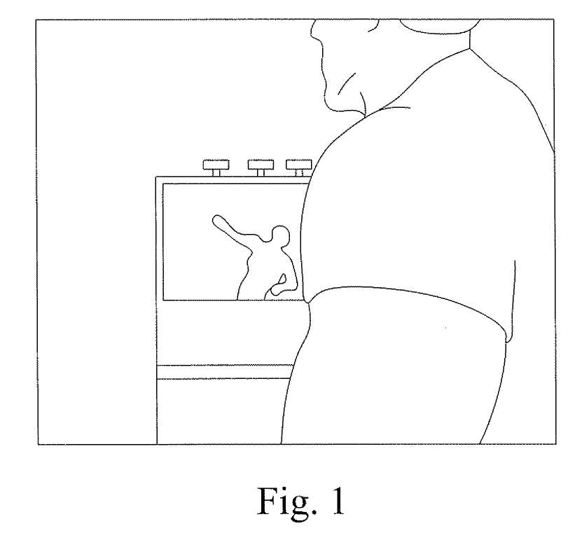

In one preferred embodiment of a system and method for mediated training to improve sports performance, each baseball player in an interactive video pitch-recognition (IAV-BB) training group individually received nine ten-minute interactive video sessions. In each session the player viewed a 45 inch rear projection video screen that showed a pitcher delivering a pitch (see FIG. 1). A training facilitator (the researcher) performed all of the interactive instructional management tasks that have since been programmed into a computer application. The facilitator introduced each drill, played the appropriate sequence video pitches, recorded the player's verbal input of pitch type and/or location, gave the player immediate corrective feedback, and provided a summary score at the end of each drill.

Specific IAV-BB drills were developed to isolate and train particular aspects of the pitch recognition skill. Drills focused on Pitch Type Only, Pitch Location Only (known type), and Combined Type/Location. As indicated by Paull and Glencross (1997), identifying the type of pitch being thrown is the first cognitive operation in the perceptual decision-making process of pitch recognition. Information on the type of pitch is then combined with early ball flight information to generate a prediction of when and where the pitch will enter the hitting zone. The second IAV-BB drill involved predicting the location in the strike zone of known types of pitches. Players are shown sets of pitches sorted by type; all fastballs, all curveballs, all sliders, etc. Location drills involved predicting the ultimate location of each pitch in a nine-cell strike zone grid (see FIG. 2)

### Research Design

The experimental design was the that of Untreated Control with Posttest Only (Cook & Campbell, 1979). The primary research question pertaining to the development of one embodiment of the method of the present invention was: Does mediated training in the cognitive skill of pitch recognition transfer to performance of the psychomotor skill of hitting as measured by game batting statistics? A secondary research questions dealt with the IAV-BB implementation: will advanced baseball players accept video-based training as realistic and valuable?

### Subjects

The pool of subjects consisted of all of the position players on the cooperating Division J college baseball team who signed a consent form indicating their willingness to participate in the project. Before training was implemented the team's coaches ranked the batters on the basis of overall hitting ability. Adjacently ranked hitters were matched in pairs. In each pair one batter was randomly assigned to the treatment group. The other player in each matched pair was assigned to the control group. The technique of matching before random assignment allowed for the creation of a control group that was similar to the experimental group while also providing the benefits of random assignment (Cook & Campbell, 1979).

The present method of IAV-BB training was done over the course of two weeks during the team's normal pre-season practice sessions. In this way the players in the training group were not asked to contribute time beyond team practice, avoiding any potential for violating NCAA policies that limit practice time of student athletes. Subjects were informed that they could withdraw at any point in the study for any reason.

### Analysis

The effect of mediated pitch recognition training on batting performance was measured by game batting statistics from a posttest period of eighteen games. The posttest period consisted of the games played after the IAV-BB training and before the start of the team's conference schedule. The statistics used are commonly calculated in baseball: Batting Average, On-Base Percentage, and Slugging Percentage. The statistical significance of difference between control and treatment groups on hitting performance measures was determined by ranking the players, both treatment and control, and applying the Mann-Whitney U-test, scaled for small n analysis. The technique was also used in an expert-novice study involving perceptual skills in table tennis (Ripoll & Latiri, 1997).

Each player in the treatment group filled out a questionnaire after the final IAV-BB training session. Players made narrative comments on the drills an the video training in general. The subjects used a scale of 1 (low) to 5 (high) to rate each of the IAV-BB drills. The players were asked to rate the drills on the basis of value. The players were also asked to rate the realism of the video display.

### Results

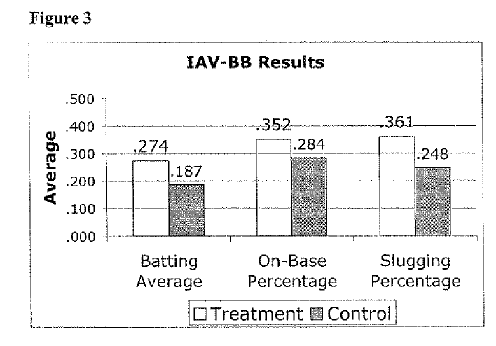

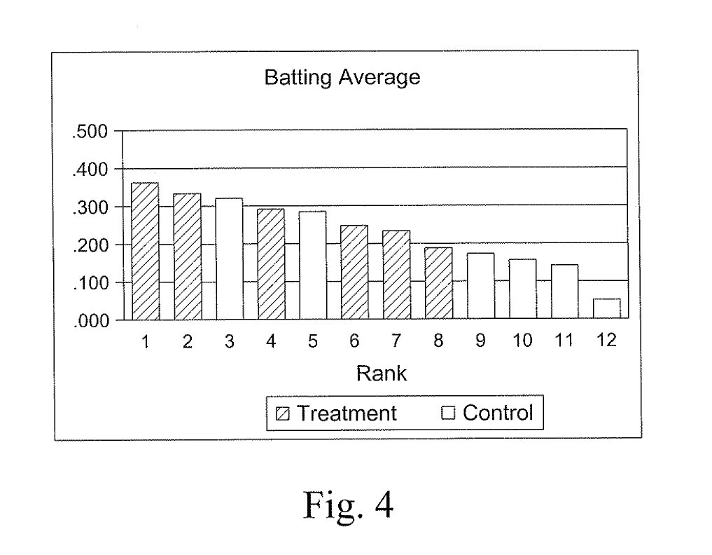

FIG. 3 presents game hitting statistics from the team's 18 game pre-conference schedule (used as the post-training test). The statistics of Batting Average, On-Base Percentage, and Slugging Percentage were calculated by the participating university's sports information. While the official batting statistics have the advantages of credibility and are accepted as measures of batting performance, there are problems with using group summary batting statistics, which are essentially “averages of averages”. Therefore, the primary treatment and control groups is stated using the Mann-Whitney U-test (see FIG. 4, 5, 6).

Batting Average divides base hits by at-bats (not counting bases-on-balls and sacrifices). On-Base Percentage includes bases-on-balls in both the numerator and the denominator. Slugging Percentage divides total bases resulting from hits (not counting bases-on-balls) by at-bats. Batting Average has long been the standard statistic for measuring batting performance (Hernandez & Bryan, 1994) but the other two statistics are considered to emphasize different aspects of hitting performance.

### Discussion

There are clearly observable differences between the treatment and control groups on all three batting measures, especially on the post-test measurements. The statistical significance of these differences is addressed using the Mann-Whitney U-test (see Table 2). The measure of Batting Average indicates a statistically significant difference (p<0.05) between treatment and control groups over the post-test period.

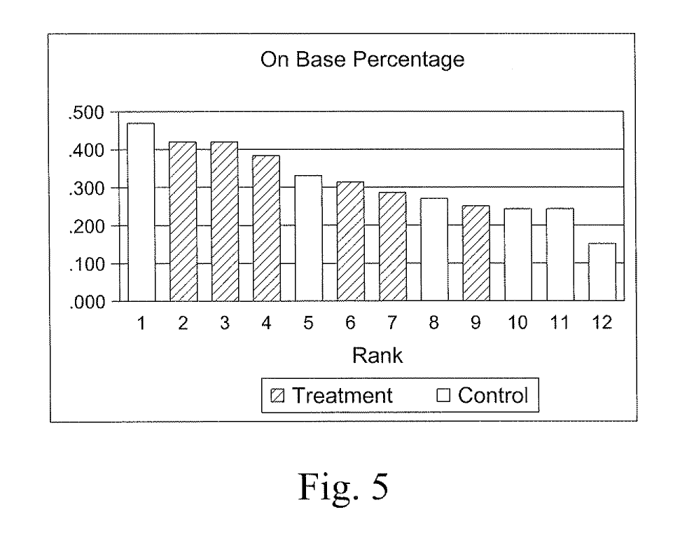

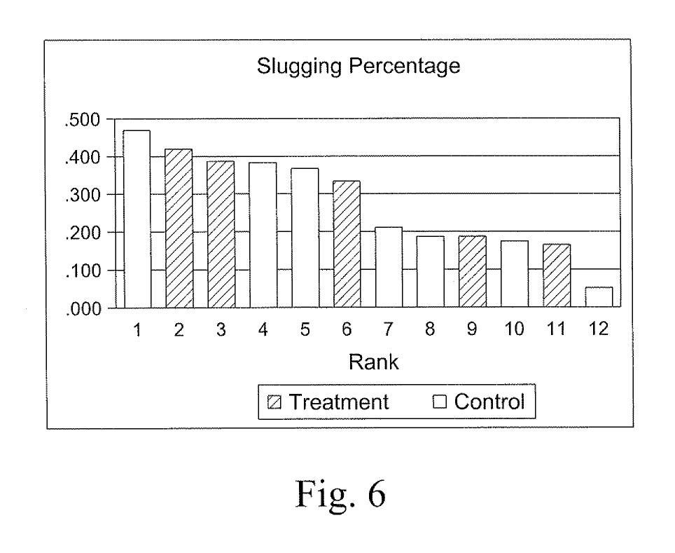

It is highly unusual to observe a significant effect of a training implementation on game performance. It application acknowledges the statistical limitations of using group summaries of batting measures. However, the Mann-Whitney U-test is based on rank of individuals within the group rather than on “averages of averages”. The ranking of treatment and control subjects with the overall group on each of the batting performance measures are presented in FIGS. 4, 5, and 6. The Mann-Whitney U-test was used to calculate p values to establish the statistical significance of observed differences between the treatment and control groups on each of the three batting performance measures. The U-test shows the measure of Batting Average to be significantly different between the treatment and, control groups while differences in the measure of On-Base Percentage and Slugging Percentage do not reach the level of statistical significance. This is the first reported use of game statistics as a measure of the effect of PDM training on psychomotor performance of the full skill and finding of a statistically significant effect on a measure of full-scale, competitive performance is potentially very meaningful.

### Post-Training Questionnaire

The players in the treatment group appeared to accept the realism of video pitches on the basis of their rating (4.1 on 5-point scale) and comments. In an expert-novice study that involved point-of-view video of a baseball pitcher, the video display was considered by the researchers to be adequately realistic based on a player-generated rating of 6.6 on a ten-point scale (Shank & Haywood, 1987). Players valued the Type Only (4.5) drills more than the Location Only (3.1) and Type Plus Location (3.6) drills.

TABLE 2
Player Questionnaire-IAV-BB Drills

| | Rating | |
|---|---|---|
| Drill | (mean) | Comments |
| Type Only | 4.5 | This made me look for keys in his arm motion to |
| | | recognize pitches early. |
| | | Very productive drill. It helped me pick up on more |
| | | things to look for (hands, skinny wrists). |
| | | Helps to read ball out of hand. |
| Location Only | 3.1 | I didn't like this much because curveballs left the |
| (known pitch type) | | screen early and were more guess work. |
| | | Some of the locations I thought were a little messed up. |
| | | Location was a little difficult. Hard to visualize the |
| | | whole distance. |
| Type + Location | 3.6 | A little harder to recognize both at the same time |
| | | This was good because it was a reaction call like in a |
| | | game. |
| | | Really had to focus on this one! A great tool. |
| | | This drill was good because the opportunity to call |
| | | pitch type as well as location gave a feel of realistic |
| | | batting situations. |
| Realism of video | 4.1 | I think that there needed to be a larger frame especially |
| pitches | | for curveballs, and see if you could center the strike |
| | | zone better. |
| | | Pitches seemed relatively realistic. |
| | | As good and realistic as a video can be. |
| | | I was surprised that it did appear very realistic and |
| | | helpful. |

### CONCLUSION

The finding that treatment players who were exposed to one embodiment of a method for providing mediated training ranked higher than control players on posttest measures of game hitting performance suggests that interactive video was an effective way for near-expert batters to improve the pitch recognition skills that have been recognized by sports science as a key difference between expert and novice performers. Interactive video training based on sports science research provides athletes and coaches with an approach for developing an aspect of expert-level performance that is generally conceded to result only from instinct or massed experience. In addition, perceptual decision-making methods in accordance with the principles of the present invention which provide mediated instruction gives an athlete seeking the expert level an opportunity for training and practice outside of the already exhausted psychomotor domain. The present method of providing mediated training has promise for accelerating the ten-year rule (Ericsson et al., 1993), helping more athletes to reach expert-level performance in less time.

The training implementation validates the cognitive information-processing (CIP) model of perceptual decision-making by decoupling the cognitive component of a complex psychomotor skill, addressing the cognitive component with mediated training, and then re-coupling the cognitive and motor components to improve performance of the full skill. While supporters of an ecological approach can fairly criticize occlusion-based expert-novice studies for breaking the perception-action link (Bootsma & Hardy, 1997), the players' acceptance of the mediated training and the performance improvement associated with the IAV-BB pitch-recognition training supports the CIP model.

### Application of PDM Training

Current trends in training technology development and research focus on enhanced realism in Virtual Reality and video game environments. The U.S. Army's co-development with commercial video game producers of training/gaming applications such as Full Spectrum Warrior illustrates this direction. But while it is important to “push the envelope” with such development it is also important to ask questions directed at discovering the best combinations of instructional technologies and methods to maximize instructional effectiveness and efficiency.

This research suggests that technically modest interactive video training may be not only adequate but optimal for developing perceptual decision-making ability in sports and potentially in other skill areas. Areas of performance that include a substantial perceptual decision-making component include use-of-force, emergency response, security, and vehicle operation. Each of these areas involves extremely rapid decision-making based on limited and changing perceptual information (mostly visual). These skill areas are similar to sports performance in that PDM is closely tied to psychomotor actions. The process can move from situation recognition to response selection to response execution in time frames of well under one second. The question is if the perception-link can be broken for the sake of focused training of the PDM component.

In one or more embodiments of a method for providing mediated training in perception decision making skills, the point of de-coupling domains of learning is that training that targets a cognitive component of a complex skill can be produced much less expensively than highly realistic simulator-type training that targets the whole psychomotor skill. In vehicle operation training, for example, cognitive training targeted at decision-making separate from manipulating vehicle controls can be done much less expensively. Obviously, vehicle manipulation must be mastered, requiring live in-vehicle and/or high fidelity simulator training. But the essential difference between skill levels in vehicle operation is not one of manipulating controls, in the same way that the expert baseball hitter's key advantage is not supreme vision and the chess master's advantage is not prodigious memory. The experts' edge is in being able to make extremely limited time—the domain of perceptual decision-making.

In another embodiment of a method for providing mediated use-of-force training for police and military, trainees must master a recognition/response election/response execution process that has life and death consequences. Officers who make slow decisions can be shot and officers who make wrong decisions can shoot innocents. In training of airline pilots, the high cost of mistakes justifies high-cost training that often includes high-fidelity simulators such as those used by the Los Angeles Police Department (McMahon, 1999). While high fidelity simulator training has been shown to be effective, it is not efficient, as trainees must leave the field to go to the site of the simulator. With many officers to train in limited time with limited simulator stations, it is impossible for a trainee to spend the hours of time needed to build the “trained reaction” that experts have. In yet another embodiment of a method for providing mediated training to officers, trainees are able to employ the method for interactive training using program on a laptop computer that focused on the PDM aspect of use-of-force actions—which could be done on the trainees own time or even in the field—it should increase the effectiveness of the much more expensive simulator training time.

The goal of the various embodiments of methods and systems for providing mediated training to enhance PDM skills is not to replace higher overhead training of the full skill in the form of live training or high fidelity simulation with the lower overhead training methods of the present invention. As is often the case with alternate instructional technologies, the question is not one of supplanting current methods but of supplementing current training techniques (Windier & Polich, 1990). The various embodiments disclosed in the present invention offer a way to target an elusive and essential aspect of expert performance that is usually considered “un-trainable” and to develop it systematically and efficiently using modest instructional technology.

1. An interactive video training method, programmed into a computer application, for targeting and enhancing cognitive recognition in a rapid response performance skill associated with baseball pitch recognition, the method comprising:
a) identifying and de-coupling a cognitive component of a psychomotor skill associated with recognizing a rapidly moving baseball and executing a rapid response involving the prediction of the ultimate location of the rapidly moving baseball in a limited time of less than 500 milliseconds that challenge human reaction time;
b) addressing the cognitive component with mediated training involving interactive video occlusion techniques, utilizing a computer that performs interactive tasks programmed into a computer application, for playing videos to provide for temporal display of a rapidly moving baseball and cutting off the visual display within 500 milliseconds, such that predicting the ultimate location of the rapidly moving baseball requires a rapid response based on limited visual information, wherein the mediated training includes:
i) editing video, using the computer programmed with a computer application, of a pitch leaving a pitcher's hand into three different lengths associated with varying degrees of difficulty where the most difficult edited video cuts to black immediately after the baseball leaves the pitcher's hand, so as to provide progressive difficulty from easier to more difficult occlusion points for pitch recognition training;
ii) displaying, utilizing the computer for performing interactive tasks programmed into a computer application, the sequence of videos of the pitch to an individual, recording the individual's response as to prediction of an ultimate location of the baseball, and providing immediate corrective feedback; and
iii) repeating the above mediated training, for training an individual to more rapidly recognize and select an accurate response; and
c) re-coupling the cognitive component with the motor skill component to improve an individual's skill in predicting of an ultimate location of a rapidly moving baseball in less than 500 milliseconds, and executing the performance of the full psychomotor skill.

2. The method of claim 1 further comprising measuring the improvement in the individual's psychomotor skills after application of the video occlusion techniques.

3. The method of claim 1 wherein the cognitive component comprises a perceptive decision making skill of reacting to a rapidly moving baseball.

4. The method of claim 3 wherein the interactive video occlusion techniques comprise displaying, using the computer programmed with the computer application, a brief video clip of a rapidly moving baseball to an individual and having the individual select a response as to prediction of an ultimate location of the baseball based on the viewer's perception of the video and providing immediate corrective feedback to the individual as to the individual's response.

5. The method of claim 4 wherein applying the video occlusion techniques comprise using the computer programmed with the computer application for progressively reducing the viewing time of the rapidly moving baseball in the video to train the individual to more rapidly recognize and select an accurate response.

6. The method of claim 5 wherein the rapidly moving baseball is a baseball pitch for improving pitch type recognition.

7. An interactive video training method, programmed into a computer application, for targeting and enhancing cognitive recognition in a rapid response performance skill associated with baseball pitch recognition, the method comprising:
identifying a cognitive component of performance skill associated with an activity that requires recognizing visual cues relating to a rapidly moving baseball and further requires executing a rapid response involving the prediction of the location of the rapidly moving baseball in a limited time of less than 500 milliseconds that challenge human reaction time;
developing video occlusion techniques, utilizing a computer that performs interactive tasks programmed into a computer application, for playing videos to provide for temporal display of a rapidly moving baseball and cutting off the visual display within 500 milliseconds, such that predicting the ultimate location of the rapidly moving baseball requires a rapid response based on limited visual information, wherein the video occlusion techniques include:
i) editing video, using the computer programmed with a computer application, of a pitch leaving a pitcher's hand into three different lengths associated with varying degrees of difficulty, where the most difficult edited video cuts to black immediately after the baseball leaves the pitcher's hand, so as to provide progressive difficulty from easier to more difficult occlusion points for measuring cognitive expertise of an individual in recognizing and selecting an accurate response;
applying the video occlusion techniques, utilizing the computer for performing interactive tasks programmed into a computer application for displaying brief video clips of a rapidly moving object to an individual, for the purpose of mediated training for enhancing an individual's skills in recognizing a rapidly moving baseball, predicting its ultimate location in less than 500 milliseconds based on limited visual information, and selecting an accurate response in executing the performance skill, wherein the application of video occlusion techniques for providing mediated training includes:
i) displaying, utilizing the computer for performing interactive tasks programmed into a computer application, the sequence of videos to an individual to provide progressive difficulty from easier to more difficult occlusion points,
ii) recording the individual's response as to prediction of an ultimate location of the baseball, and
iii) providing immediate corrective feedback to the individual, and
iv) repeating the above mediated training in order to increase speed and accuracy of an individuals' prediction of ultimate location of a rapidly moving baseball.

8. The method of claim 7 further comprising measuring the improvement in the individual's performance skill after application of the video occlusion techniques.

9. The method of claim 7 wherein the cognitive component comprises a perceptive decision making skill of reacting to a rapidly moving baseball.

10. The method of claim 9 wherein the video occlusion techniques comprise utilizing the computer programmed with the computer application for displaying a brief video clip of a rapidly moving baseball to an individual and having the individual select a response based on the viewer's perception of the video.

11. The method of claim 10 wherein applying the video occlusion technique comprise utilizing the computer programmed with the computer application for progressively reducing the viewing time of the rapidly moving baseball in the video to train the individual to more rapidly recognize and select an accurate response.

12. The method of claim 11 wherein the rapidly moving baseball is a baseball pitch for improving pitch type recognition and selecting an accurate response to improve the individual's batting performance.

13. The method of claim 7 wherein recording the individual's response comprises the individual selecting a predicted outcome to the rapidly moving baseball video and providing immediate corrective feedback comprises immediately providing the individual with the outcome of the rapidly moving baseball after the individual has made a selection.

14. The method of claim 13 wherein the rapidly moving baseball is a baseball pitch for improving pitch type recognition.

15. The method of claim 13 wherein the rapidly moving baseball is a baseball pitch for improving pitch type recognition and selecting an accurate response to improve the individual's batting performance.

16. An interactive video training system for providing mediated training to improve a sports performance based skill requiring a rapid response in a limited time period, the interactive video system comprising:
a video means for performing the interactive video occlusion technique of temporally displaying to an individual a succession of videos of a rapidly moving baseball that requires the prediction of an ultimate location of a rapidly moving baseball within 500 milliseconds,
a computer for performing interactive tasks programmed into a computer application, for introducing and playing the succession of videos utilizing the video means, which are displayed for a limited viewing time of less than 500 milliseconds, such that predicting the ultimate location of the rapidly moving baseball requires a rapid response based on limited visual information, wherein the computer and video means for performing the interactive video occlusion technique is configured to enable editing video of a pitch leaving a pitcher's hand in three different lengths associated with varying degrees of difficulty, where the most difficult edited video cuts to black immediately after the baseball leaves the pitcher's hand, so as to provide progressive difficulty from easier to more difficult occlusion points for pitch recognition training;
a selection means for enabling the individual to select a predicted outcome and ultimate location of the rapidly moving baseball, and for providing immediate corrective feedback to the individual; and
wherein the computer application for introducing and playing the succession of videos via the video means is configured to display a sequence of videos of a baseball pitch to an individual so as to progressively reduce the viewing time of the rapidly moving baseball, and the selection means is configured to record the individual's prediction of an ultimate location of the baseball and provide immediate corrective feedback to the individual, to train the individual to more rapidly recognize visual cues of the rapidly moving baseball, predict its ultimate location based on limited visual information, and select an accurate response to the rapidly moving baseball for enhancing the individual's sports performance skill.

17. The interactive system of claim 16 wherein the selection means is configured to immediately provide the individual with the outcome of the rapidly moving baseball after the individual has made a selection, to provide corrective training to the individual.

18. The interactive system of claim 17, wherein the rapidly moving baseball is a baseball pitch for improving an individual's selection of an accurate response to improve the individual's batting performance.

19. The interactive system of claim 16 wherein the computer for performing interactive tasks programmed into a computer application is configured to progressively reduce the viewing time of the rapidly moving object in successively displayed video clips to train the individual to more rapidly recognize and select an accurate response.

20. The interactive system of claim 19, wherein the rapidly moving baseball is a baseball pitch for improving pitch type recognition.
